(19) United States
(12) Patent Application Publication
(10) Pub. No.: US 2017/0068330 A1
(43) Pub. Date: Mar. 9, 2017

(54) PREPROCESSING FOR NONLINEAR STYLUS PROFILES

(71) Applicant: Apple Inc., Cupertino, CA (US)

(72) Inventors: Seyed Mohammad NAVIDPOUR, San Jose, CA (US); Apexit SHAH, Cupertino, CA (US); Wayne Carl WESTERMAN, Burlingame, CA (US)

(21) Appl. No.: 14/964,514

(22) Filed: Dec. 9, 2015

Related U.S. Application Data
(60) Provisional application No. 62/215,867, filed on Sep. 9, 2015.

(51) Int. Cl. G06F 3/038; G06F 3/0354; G06F 3/041

(52) U.S. Cl. CPC G06F 3/038; G06F 3/0418; G06F 3/03545

(57) ABSTRACT

Pre-processing can be applied to raw signal measurements resulting from stimulation from an input device, such as an active stylus, having a non-linear signal profile. The pre-processing can include a non-linear transformation, which can linearize the signal profile and thereby reduce wobble resulting from location detection algorithms. The transformation can be selected based on the signal profile for the stylus and the ideal profile for the location detection algorithms. In some examples, the transformation can be applied to linearize the entire signal profile, but in other examples, the non-linear transformation can be applied only to specific regions of the signal profile. The pre-processing can also discard raw signal measurements that are at least a threshold distance from the peak signal measurement or raw signal measurements below a threshold signal level. Pre-processing raw signal measurements before detecting location can reduce wobble across a range of stimulation frequencies and stylus orientations.

### CROSS REFERENCE TO RELATED APPLICATION

This application claims the benefit of U.S. Provisional Application No. 62/215,867, filed Sep. 9, 2015, the contents of which are incorporated herein by reference in its entirety for all purposes.

### FIELD

This relates generally to input devices for use with touch-sensitive devices and, more specifically, to pre-processing for non-linear stylus profiles to reduce wobble.

### BACKGROUND

Many types of input devices are presently available for performing operations in a computing system, such as buttons or keys, mice, trackballs, joysticks, touch panels, touch screens and the like. Touch-sensitive devices, and touch screens in particular, are quite popular because of their ease and versatility of operation as well as their affordable prices. A touch-sensitive device can include a touch panel, which can be a clear panel with a touch-sensitive surface, and a display device such as a liquid crystal display (LCD) that can be positioned partially or fully behind the panel so that the touch-sensitive surface can cover at least a portion of the viewable area of the display device. The touch-sensitive device can allow a user to perform various functions by touching or hovering over the touch panel using a finger, stylus or other object at a location often dictated by a user interface (UI) being displayed by the display device. In general, the touch-sensitive device can recognize a touch or hover event and the position of the event on the touch panel, and the computing system can then interpret the event in accordance with the display appearing at the time of the event, and thereafter can perform one or more actions based on the event.

Styli have become popular input devices for touch-sensitive devices. In particular, use of an active stylus capable of generating stylus stimulation signals that can be sensed by the touch-sensitive device can improve the precision and control of the stylus. The effectiveness of a stylus, however, can depend on the ability to accurately calculate the position of the stylus on a touch-sensitive device.

### SUMMARY

This relates to reducing wobble for an input device, such as an active stylus. Pre-processing can be applied to raw signal measurements for a stylus having a non-linear signal profile. The pre-processing can include a non-linear transformation, which can linearize the signal profile and thereby reduce wobble resulting from location detection algorithms. The transformation can be selected based on the signal profile for the stylus and the ideal profile for the location detection algorithms. In some examples, the transformation can be applied to linearize the entire signal profile, but in other examples, the non-linear transformation can be applied only to specific regions of the signal profile. The pre-processing can also discard raw signal measurements that are at least a threshold distance from the peak signal measurement or raw signal measurements below a threshold signal level. Pre-processing raw signal measurements before applying location detection algorithms can reduce wobble across a range of stimulation frequencies and orientations of the active stylus.

### BRIEF DESCRIPTION OF THE DRAWINGS

FIGS. 1A-1D illustrate examples of systems with touch screens that can accept input from an active stylus according to examples of the disclosure.

FIG. 2 illustrates a block diagram of an example computing system that can receive input from an active stylus according to examples of the disclosure.

FIG. 3 illustrates an example touch screen including touch sensing circuitry configured as drive and sense regions or lines according to examples of the disclosure.

FIG. 4 illustrates an example touch screen including touch sensing circuitry configured as pixelated electrodes according to examples of the disclosure.

FIG. 5 illustrates an example active stylus according to examples of the disclosure.

FIG. 6 illustrates an example touch sensor panel configuration operable with the touch ASIC of FIG. 2 to perform a stylus scan according to examples of the disclosure.

FIG. 7 illustrates an example touch sensor panel configuration operable with the touch ASIC of FIG. 2 to perform a stylus spectral analysis scan according to examples of the disclosure.

FIG. 8 illustrates an example wobble according to examples of the disclosure.

FIG. 9 illustrates an example raw signal profile and an example ideal signal profile according to examples of the disclosure.

FIG. 10 illustrates example modified signal profiles after pre-processing transformation according to examples of the disclosure.

FIG. 11 illustrates an example plot of a function for mapping raw signal measurements to modified signal measurements according to examples of the disclosure.

FIG. 12 illustrates applying a pre-processing transform to a raw signal profile according to examples of the disclosure.

FIG. 13 illustrates applying a pre-processing transform to a portion of the raw signal profile according to examples of the disclosure.

FIG. 14 illustrates an example process for reducing wobble according to examples of the disclosure.

FIG. 15 illustrates an example block diagram of modules configured for reducing wobble according to examples of the disclosure.

### DETAILED DESCRIPTION

In the following description of examples, reference is made to the accompanying drawings in which it is shown by way of illustration specific examples that can be practiced. It is to be understood that other examples can be used and structural changes can be made without departing from the scope of the various examples.

This relates to reducing wobble for an input device, such as an active stylus. Pre-processing can be applied to raw signal measurements for a stylus having a non-linear signal profile. The pre-processing can include a non-linear transformation, which can linearize the signal profile and thereby reduce wobble resulting from location detection algorithms. The transformation can be selected based on the signal profile for the stylus and the ideal profile for the location detection algorithms. In some examples, the transformation can be applied to linearize the entire signal profile, but in other examples, the non-linear transformation can be applied only to specific regions of the signal profile. The pre-processing can also discard raw signal measurements that are at least a threshold distance from the peak signal measurement or raw signal measurements below a threshold signal level. Pre-processing raw signal measurements before applying location detection algorithms can reduce wobble across a range of stimulation frequencies and orientations of the active stylus.

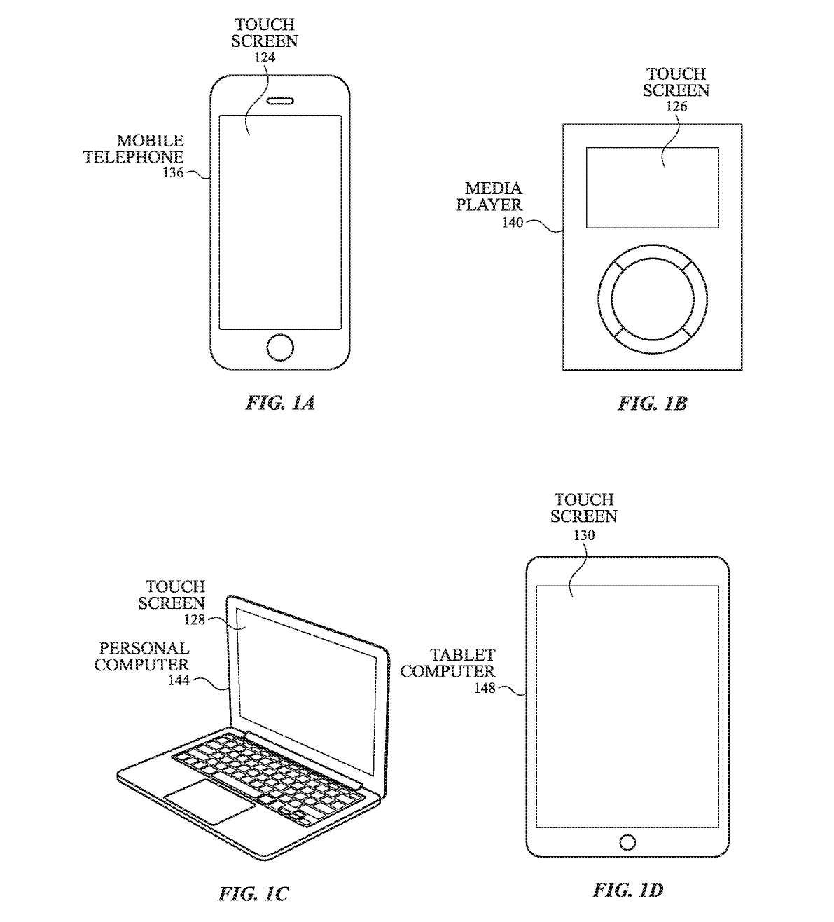

FIGS. 1A-1D illustrate examples of systems with touch screens that can accept input from an active stylus according to examples of the disclosure. FIG. 1A illustrates an exemplary mobile telephone 136 that includes a touch screen 124 that can accept input from an active stylus according to examples of the disclosure. FIG. 1B illustrates an example digital media player 140 that includes a touch screen 126 that can accept input from an active stylus according to examples of the disclosure. FIG. 1C illustrates an example personal computer 144 that includes a touch screen 128 that can accept input from an active stylus according to examples of the disclosure. FIG. 1D illustrates an example tablet computing device 148 that includes a touch screen 130 that can accept input from an active stylus according to examples of the disclosure. Other devices, including wearable devices, can accept input from an active stylus according to examples of the disclosure.

Touch screens 124, 126, 128 and 130 can be based on, for example, self-capacitance or mutual capacitance sensing technology, or another touch sensing technology. For example, in a self-capacitance based touch system, an individual electrode with a self-capacitance to ground can be used to form a touch pixel (touch node) for detecting touch. As an object approaches the touch pixel, an additional capacitance to ground can be formed between the object and the touch pixel. The additional capacitance to ground can result in a net increase in the self-capacitance seen by the touch pixel. This increase in self-capacitance can be detected and measured by a touch sensing system to determine the positions of multiple objects when they touch the touch screen.

A mutual capacitance based touch system can include, for example, drive regions and sense regions, such as drive lines and sense lines. For example, drive lines can be formed in rows while sense lines can be formed in columns (i.e., orthogonal). Touch pixels (touch nodes) can be formed at the intersections or adjacencies (in single layer configurations) of the rows and columns. During operation, the rows can be stimulated with an alternating current (AC) waveform and a mutual capacitance can be formed between the row and the column of the touch pixel. As an object approaches the touch pixel, some of the charge being coupled between the row and column of the touch pixel can instead be coupled onto the object. This reduction in charge coupling across the touch pixel can result in a net decrease in the mutual capacitance between the row and the column and a reduction in the AC waveform being coupled across the touch pixel. This reduction in the charge-coupled AC waveform can be detected and measured by the touch sensing system to determine the positions of multiple objects when they touch the touch screen. In some examples, a touch screen can be multi-touch, single touch, projection scan, full-imaging multi-touch, or any capacitive touch.

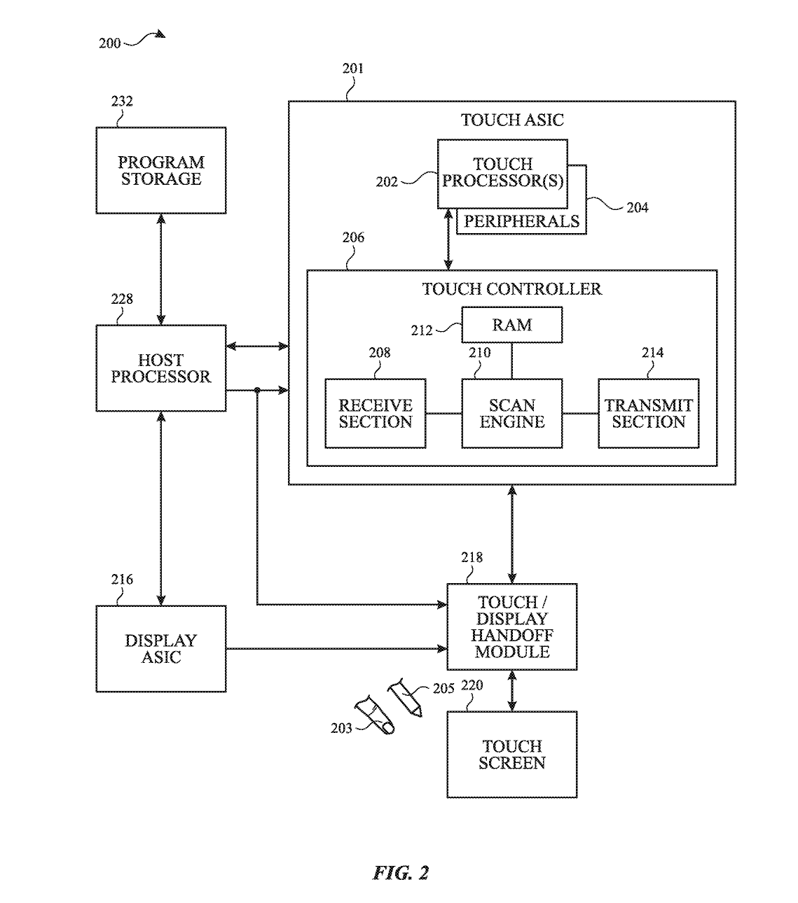

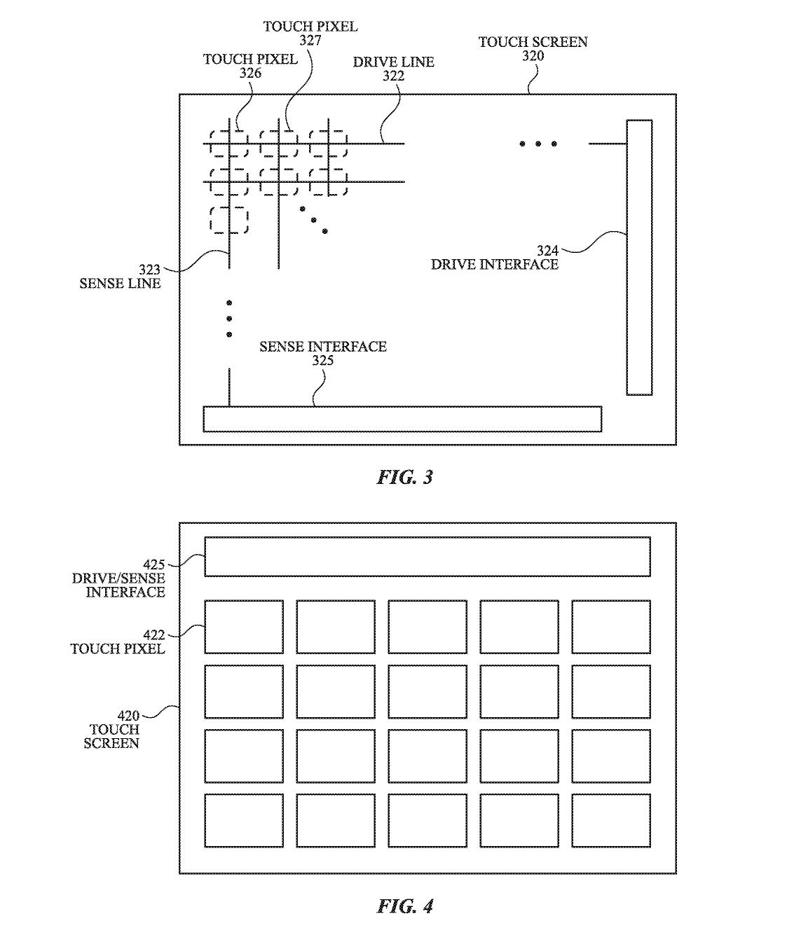

FIG. 2 illustrates a block diagram of an example computing system 200 that can receive input from an active stylus according to examples of the disclosure. Computing system 200 could be included in, for example, mobile telephone 136, digital media player 140, personal computer 144, tablet computing device 148, wearable device, or any mobile or non-mobile computing device that includes a touch screen. Computing system 200 can include an integrated touch screen 220 to display images and to detect touch and/or proximity (e.g., hover) events from an object (e.g., finger 203 or active or passive stylus 205) at or proximate to the surface of the touch screen 220. Computing system 200 can also include an application specific integrated circuit (“ASIC”) illustrated as touch ASIC 201 to perform touch and/or stylus sensing operations. Touch ASIC 201 can include one or more touch processors 202, peripherals 204, and touch controller 206. Touch ASIC 201 can be coupled to touch sensing circuitry of touch screen 220 to perform touch and/or stylus sensing operations (described in more detail below). Peripherals 204 can include, but are not limited to, random access memory (RAM) or other types of memory or storage, watchdog timers and the like. Touch controller 206 can include, but is not limited to, one or more sense channels in receive section 208, panel scan engine 210 (which can include channel scan logic) and transmit section 214 (which can include analog or digital driver logic). In some examples, the transmit section 214 and receive section 208 can be reconfigurable by the panel scan engine 210 based the scan event to be executed (e.g., mutual capacitance row-column scan, mutual capacitance row-row scan, mutual capacitance column-column scan, row self-capacitance scan, column self-capacitance scan, touch spectral analysis scan, stylus spectral analysis scan, stylus scan, etc.). Panel scan engine 210 can access RAM 212, autonomously read data from the sense channels and provide control for the sense channels. The touch controller 206 can also include a scan plan (e.g., stored in RAM 212) which can define a sequence of scan events to be performed at the touch screen. The scan plan can include information necessary for configuring or reconfiguring the transmit section and receive section for the specific scan event to be performed. Results (e.g., touch signals or touch data) from the various scans can also be stored in RAM 212. In addition, panel scan engine 210 can provide control for transmit section 214 to generate stimulation signals at various frequencies and/or phases that can be selectively applied to drive regions of the touch sensing circuitry of touch screen 220. Touch controller 206 can also include a spectral analyzer to determine low noise frequencies for touch and stylus scanning. The spectral analyzer can perform spectral analysis on the scan results from an unstimulated touch screen. Although illustrated in FIG. 2 as a single ASIC, the various components and/or functionality of the touch ASIC 201 can be implemented with multiple circuits, elements, chips, and/or discrete components.

Computing system 200 can also include an application specific integrated circuit illustrated as display ASIC 216 to perform display operations. Display ASIC 216 can include hardware to process one or more still images and/or one or more video sequences for display on touch screen 220. Display ASIC 216 can be configured to generate read memory operations to read the data representing the frame/video sequence from a memory (not shown) through a memory controller (not shown), for example. Display ASIC 216 can be configured to perform various processing on the image data (e.g., still images, video sequences, etc.). In some examples, display ASIC 216 can be configured to scale still images and to dither, scale and/or perform color space conversion on the frames of a video sequence. Display ASIC 216 can be configured to blend the still image frames and the video sequence frames to produce output frames for display. Display ASIC 216 can also be more generally referred to as a display controller, display pipe, display control unit, or display pipeline. The display control unit can be generally any hardware and/or firmware configured to prepare a frame for display from one or more sources (e.g., still images and/or video sequences). More particularly, display ASIC 216 can be configured to retrieve source frames from one or more source buffers stored in memory, composite frames from the source buffers, and display the resulting frames on touch screen 220. Accordingly, display ASIC 216 can be configured to read one or more source buffers and composite the image data to generate the output frame.

Display ASIC 216 can provide various control and data signals to the display, including timing signals (e.g., one or more clock signals) and/or vertical blanking period and horizontal blanking interval controls. The timing signals can include a pixel clock that can indicate transmission of a pixel. The data signals can include color signals (e.g., red, green, blue). The display ASIC 216 can control the touch screen 220 in real-time, providing the data indicating the pixels to be displayed as the touch screen is displaying the image indicated by the frame. The interface to such a touch screen 220 can be, for example, a video graphics array (VGA) interface, a high definition multimedia interface (HDMI), a digital video interface (DVI), a LCD interface, a plasma interface, or any other suitable interface.

In some examples, a handoff module 218 can also be included in computing system 200. Handoff module 218 can be coupled to the touch ASIC 201, display ASIC 216, and touch screen 220, and can be configured to interface the touch ASIC 201 and display ASIC 216 with touch screen 220. The handoff module 212 can appropriately operate the touch screen 220 according to the scanning/sensing and display instructions from the touch ASIC 201 and the display ASIC 216. In other examples, the display ASIC 216 can be coupled to display circuitry of touch screen 220 and touch ASIC 201 can be coupled to touch sensing circuitry of touch screen 220 without handoff module 218.

Touch screen 220 can use liquid crystal display (LCD) technology, light emitting polymer display (LPD) technology, organic LED (OLED) technology, or organic electro luminescence (OEL) technology, although other display technologies can be used in other examples. In some examples, the touch sensing circuitry and display circuitry of touch screen 220 can be stacked on top of one another. For example, a touch sensor panel can cover some or all of a surface of the display (e.g., fabricated one on top of the next in a single stack-up or formed from adhering together a touch sensor panel stack-up with a display stack-up). In other examples, the touch sensing circuitry and display circuitry of touch screen 220 can be partially or wholly integrated with one another. The integration can be structural and/or functional. For example, some or all of the touch sensing circuitry can be structurally in between the substrate layers of the display (e.g., between two substrates of a display pixel cell). Portions of the touch sensing circuitry formed outside of the display pixel cell can be referred to as “on-cell” portions or layers, whereas portions of the touch sensing circuitry formed inside of the display pixel cell can be referred to as “in cell” portions or layers. Additionally, some electronic components can be shared, and used at times as touch sensing circuitry and at other times as display circuitry. For example, in some examples, common electrodes can be used for display functions during active display refresh and can be used to perform touch sensing functions during touch sensing periods. A touch screen stack-up sharing components between sensing functions and display functions can be referred to as an in-cell touch screen.

Computing system 200 can also include a host processor 228 coupled to the touch ASIC 201, and can receive outputs from touch ASIC 201 (e.g., from touch processor 202 via a communication bus, such as an serial peripheral interface (SPI) bus, for example) and perform actions based on the outputs. Host processor 228 can also be connected to program storage 232 and display ASIC 216. Host processor 228 can, for example, communicate with display ASIC 216 to generate an image on touch screen 220, such as an image of a user interface (UI), and can use touch ASIC 201 (including touch processor 202 and touch controller 206) to detect a touch on or near touch screen 220, such as a touch input to the displayed UI. The touch input can be used by computer programs stored in program storage 232 to perform actions that can include, but are not limited to, moving an object such as a cursor or pointer, scrolling or panning, adjusting control settings, opening a file or document, viewing a menu, making a selection, executing instructions, operating a peripheral device connected to the host device, answering a telephone call, placing a telephone call, terminating a telephone call, changing the volume or audio settings, storing information related to telephone communications such as addresses, frequently dialed numbers, received calls, missed calls, logging onto a computer or a computer network, permitting authorized individuals access to restricted areas of the computer or computer network, loading a user profile associated with a user's preferred arrangement of the computer desktop, permitting access to web content, launching a particular program, encrypting or decoding a message, and/or the like. Host processor 228 can also perform additional functions that may not be related to touch processing.

Computing system 200 can include one or more processors, which can execute software or firmware implementing various functions. Specifically, for integrated touch screens which share components between touch and/or stylus sensing and display functions, the touch ASIC and display ASIC can be synchronized so as to properly share the circuitry of the touch sensor panel. The one or more processors can include one or more of the one or more touch processors 202, a processor in display ASIC 216, and/or host processor 228. In some examples, the display ASIC 216 and host processor 228 can be integrated into a single ASIC, though in other examples, the host processor 228 and display ASIC 216 can be separate circuits coupled together. In some examples, host processor 228 can act as a master circuit and can generate synchronization signals that can be used by one or more of the display ASIC 216, touch ASIC 201 and handoff module 218 to properly perform sensing and display functions for an in-cell touch screen. The synchronization signals can be communicated directly from the host processor 228 to one or more of the display ASIC 216, touch ASIC 201 and handoff module 218. Alternatively, the synchronization signals can be communicated indirectly (e.g., touch ASIC 201 or handoff module 218 can receive the synchronization signals via the display ASIC 216).

Computing system 200 can also include a wireless module (not shown). The wireless module can implement a wireless communication standard such as a WiFi®, BLUETOOTH™ or the like. The wireless module can be coupled to the touch ASIC 201 and/or host processor 228. The touch ASIC 201 and/or host processor 228 can, for example, transmit scan plan information, timing information, and/or frequency information to the wireless module to enable the wireless module to transmit the information to an active stylus, for example (i.e., a stylus capable generating and injecting a stimulation signal into a touch sensor panel). For example, the computing system 200 can transmit frequency information indicative of one or more low noise frequencies the stylus can use to generate a stimulation signals. Additionally or alternatively, timing information can be used to synchronize the stylus 205 with the computing system 200, and the scan plan information can be used to indicate to the stylus 205 when the computing system 200 performs a stylus scan and expects stylus stimulation signals (e.g., to save power by generating a stimulus only during a stylus scan period). In some examples, the wireless module can also receive information from peripheral devices, such as an active stylus 205, which can be transmitted to the touch ASIC 201 and/or host processor 228. In other examples, the wireless communication functionality can be incorporated in other components of computing system 200, rather than in a dedicated chip.

Note that one or more of the functions described herein can be performed by firmware stored in memory and executed by the touch processor in touch ASIC 201, or stored in program storage and executed by host processor 228. The firmware can also be stored and/or transported within any non-transitory computer-readable storage medium for use by or in connection with an instruction execution system, apparatus, or device, such as a computer-based system, processor-containing system, or other system that can fetch the instructions from the instruction execution system, apparatus, or device and execute the instructions. In the context of this document, a “non-transitory computer-readable storage medium” can be any medium (excluding a signal) that can contain or store the program for use by or in connection with the instruction execution system, apparatus, or device. The non-transitory computer readable medium storage can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

The firmware can also be propagated within any transport medium for use by or in connection with an instruction execution system, apparatus, or device, such as a computer-based system, processor-containing system, or other system that can fetch the instructions from the instruction execution system, apparatus, or device and execute the instructions. In the context of this document, a “transport medium” can be any medium that can communicate, propagate or transport the program for use by or in connection with the instruction execution system, apparatus, or device. The transport readable medium can include, but is not limited to, an electronic, magnetic, optical, electromagnetic or infrared wired or wireless propagation medium.

It is to be understood that the computing system 200 is not limited to the components and configuration of FIG. 2, but can include other or additional components in multiple configurations according to various examples. Additionally, the components of computing system 200 can be included within a single device, or can be distributed between multiple devices.

As discussed above, the touch screen 220 can include touch sensing circuitry. FIG. 3 illustrates an example touch screen including touch sensing circuitry configured as drive and sense regions or lines according to examples of the disclosure. Touch screen 320 can include touch sensing circuitry that can include a capacitive sensing medium having a plurality of drive lines 322 and a plurality of sense lines 323. It should be noted that the term “lines” is sometimes used herein to mean simply conductive pathways, as one skilled in the art will readily understand, and is not limited to elements that are strictly linear, but includes pathways that change direction, and includes pathways of different size, shape, materials, etc. Additionally, the drive lines 322 and sense lines 323 can be formed from smaller electrodes coupled together to form drive lines and sense lines. Drive lines 322 can be driven by stimulation signals from the transmit section 214 through a drive interface 324, and resulting sense signals generated in sense lines 323 can be transmitted through a sense interface 325 to sense channels in receive section 208 (also referred to as an event detection and demodulation circuit) in touch controller 206. In this way, drive lines and sense lines can be part of the touch sensing circuitry that can interact to form capacitive sensing nodes, which can be thought of as touch picture elements (touch pixels), such as touch pixels 326 and 327. This way of understanding can be particularly useful when touch screen 320 is viewed as capturing an “image” of touch. In other words, after touch controller 206 has determined whether a touch has been detected at each touch pixel in the touch screen, the pattern of touch pixels in the touch screen at which a touch occurred can be thought of as an “image” of touch (e.g., a pattern of fingers or other objects touching the touch screen).

It should be understood that the row/drive and column/sense associations can be exemplary, and in other examples, columns can be drive lines and rows can be sense lines. In some examples, row and column electrodes can be perpendicular such that touch nodes can have x and y coordinates, though other coordinate systems can also be used, and the coordinates of the touch nodes can be defined differently. It should be understood that touch screen 220 can include any number of row electrodes and column electrodes to form the desired number and pattern of touch nodes. The electrodes of the touch sensor panel can be configured to perform various scans including some or all of row-column and/or column-row mutual capacitance scans, self-capacitance row and/or column scans, row-row mutual capacitance scans, column-column mutual capacitance scans, and stylus scans.

Additionally or alternatively, the touch screen can include touch sensing circuitry including an array of pixelated electrodes. FIG. 4 illustrates an example touch screen including touch sensing circuitry configured as pixelated electrodes according to examples of the disclosure. Touch screen 420 can include touch sensing circuitry that can include a capacitive sensing medium having a plurality of electrically isolated touch pixel electrodes 422 (e.g., a pixelated touch screen). For example, in a self-capacitance configuration, touch pixel electrodes 422 can be coupled to sense channels in receive section 208 in touch controller 206, can be driven by stimulation signals from the sense channels (or transmit section 214) through drive/sense interface 425, and can be sensed by the sense channels through the drive/sense interface as well, as described above. Labeling the conductive plates used to detect touch (i.e., touch pixel electrodes 422) as “touch pixel” electrodes can be particularly useful when touch screen 420 is viewed as capturing an “image” of touch. In other words, after touch controller 206 has determined an amount of touch detected at each touch pixel electrode 422 in touch screen 420, the pattern of touch pixel electrodes in the touch screen at which a touch occurred can be thought of as an “image” of touch (e.g., a pattern of fingers or other objects touching the touch screen). The pixelated touch screen can be used to sense mutual capacitance and/or self-capacitance.

As discussed herein, in addition to performing touch scans to detect an object such as a finger or a passive stylus, computing system 200 can also perform stylus scans to detect an active stylus and can communicate with a stylus. For example, an active stylus can be used as an input device on the surface of a touch screen of touch-sensitive device. FIG. 5 illustrates an example active stylus according to examples of the disclosure. Stylus 500 can include one or more electrodes 502, which can be located, for example, at a distal end of the stylus (e.g., the tip of the stylus). As illustrated in FIG. 5, stylus 500 can include a tip electrode 501 and a ring electrode 503. Tip electrode 501 can include a material capable of transmitting the stylus stimulation signal from stylus stimulation circuitry 504 to the touch-sensitive device, such as a flexible conductor, a metal, a conductor wrapped by a non-conductor, a non-conductor coated with a metal, a transparent conducting material (e.g., indium tin oxide (ITO)) or a transparent non-conductive material (e.g., glass) coated with a transparent (e.g., ITO) (if the tip is also used for projection purposes) or opaque material, or the like. In some examples, the stylus tip can have a diameter of 2 mm or less. In some examples, the stylus tip can have a diameter between 1 mm and 2 mm. Ring electrode 503 can include a conductive material, such as a flexible conductor, a metal, a conductor wrapped by a non-conductor, a non-conductor coated with a metal, a transparent conducting material (e.g., ITO) or a transparent non-conductive material (e.g., glass) coated with a transparent (e.g., ITO if the tip is used for projection purposes) or opaque material, or the like.

Stylus 500 can also include stylus stimulation circuitry 504. Stylus stimulation circuitry 504 can be configured to generate one or more stylus stimulation signals at the one or more electrodes 502 to stimulate a touch-sensitive device. For example, stylus stimulation signals can be coupled from stylus 500 to the touch sensing circuitry of touch screen 220, and the received signals can be processed by the touch ASIC 201. The received signals can be used to determine a location of active stylus 500 at the surface of touch screen 220.

The operation of stylus stimulation circuitry 504 can be controlled by a processor 506. For example, the processor can be configured to communicate with the stylus stimulation circuitry to control the generation of stimulation signals. In some examples, the communication between the processor and stylus stimulation circuitry can be accomplished via an SPI bus, and the stylus stimulation circuitry can operate as an SPI slave device. In some examples, the stylus 500 can include more than one processor, and stylus stimulation circuitry 504 can include one or more processors. In some examples, one or more of the stylus functions described herein can be performed by firmware stored in memory or in program storage (not shown) and executed by processor 506 or a processor in stylus stimulation circuitry 504.

In some examples, stylus 500 can also include a force sensor 508 to detect the amount of force at the tip of the stylus 500. For example, when the stylus tip is touching touch screen 220, the force sensor 508 can measure the force at the stylus tip. The force information can be stored in the stylus (e.g., in a memory (not shown)) and/or transmitted (via a wired connection or wirelessly) to the computing system 200. For example, the force information can be communicated to host processor 228 or touch ASIC 201 in computing system 200. Force information and corresponding location information can be processed together by host processor 228 and/or touch ASIC 201.

In some examples, force sensor 508 can be coupled to processor 506. Processor 506 can process force information from force sensor 508 and, based on the force information, control stylus stimulation circuitry 504 to generate or not generate stylus stimulation signals. For example, the processor can cause stylus stimulation circuitry 504 to generate no stylus stimulation signals when no force is detected or when the force is below a threshold level. When a force (or a force at or above the threshold level) is detected (e.g., corresponding to touch-down of the stylus), the processor can cause stylus stimulation circuitry 504 to generate stylus stimulation signals and continue generating stylus stimulation signals until the detected force drops below the threshold level (or some other threshold level).

Stylus 500 can also include a wireless communication circuit 510, although in some examples the wireless communication functionality can be incorporated into other modules within the stylus 500, and in other examples the stylus can communicate via a wired connection. Wireless communication circuit 510 can transmit the force information from the stylus 500 to the wireless communication circuitry of computing system 200. The wireless communication circuit 510 can also receive other information including, but not limited to, information about stylus stimulus frequencies, scan plan information (i.e., the sequence of scans to be performed by the touch-sensitive device) and clock synchronization information. For example, the touch-sensitive device can transmit one or more low noise frequencies to the stylus 500, and stylus stimulation circuitry 504 can generate stimulation signals electrodes 502 based on, or at, the one or more low noise frequencies. In some examples, the stylus stimulation circuitry 504 can generate stimulation signals at two or more different frequencies (e.g., at one frequency at the ring electrode and at a second frequency at the tip electrode), though in other examples, stimulation signals are only generated by the stylus at one frequency. In some examples, information, such as information about stylus stimulation frequencies and scan event plans, can be transmitted from touch ASIC 201 to the wireless communication unit of computing system 200 via host processor 228. In other examples, information, such as clock synchronization information, can be communicated directly from touch ASIC 201 to wireless communication unit of computing system 200.

In some examples, stylus 500 can operate asynchronously from the computing system 200. In an asynchronous example, the stylus can continuously generate stimulation signals, generate stimulation signals at various intervals, or generate stimulation signals when force is detected by the force sensor 508. In other examples, wireless communication can be used to synchronize the stylus 500 and computing system 200. For example, the stylus 500 can receive clock synchronization information and scan plans from computing system 200 such that it can generate stimulation signals when the computing system expects such stimulation signals from the stylus. For example, the clock synchronization information can provide an updated value for the stylus clock (e.g., a timer, counter, etc.) or reset the stylus clock so that the stylus clock can be substantially the same as (or otherwise track) a system clock for the touch-sensitive device. The stylus can then use the scan plan, which can define the sequence of scan events to be performed by the touch-sensitive device at specific times, and the stylus clock to determine when the touch-sensitive device expects stylus stimulation signals to be generated. When the computing system 200 is not expecting stylus stimulation signals, the stylus can stop generating stimulation signals. Additionally, in some examples, the computing system 200 and stylus 500 can synchronize their communication to regular time intervals such that both the computing system 200 and stylus 500 can save power. For example, after the stylus and computing system pair via a wireless communication channel, the communication between the stylus and computing system can occur only at specified times (based on their respective synchronized clocks). Stylus 500 and/or computing system 200 can include one or more crystals to generate stable and accurate clock signals to improve synchronization and reduce drift between the computing system and stylus clocks.

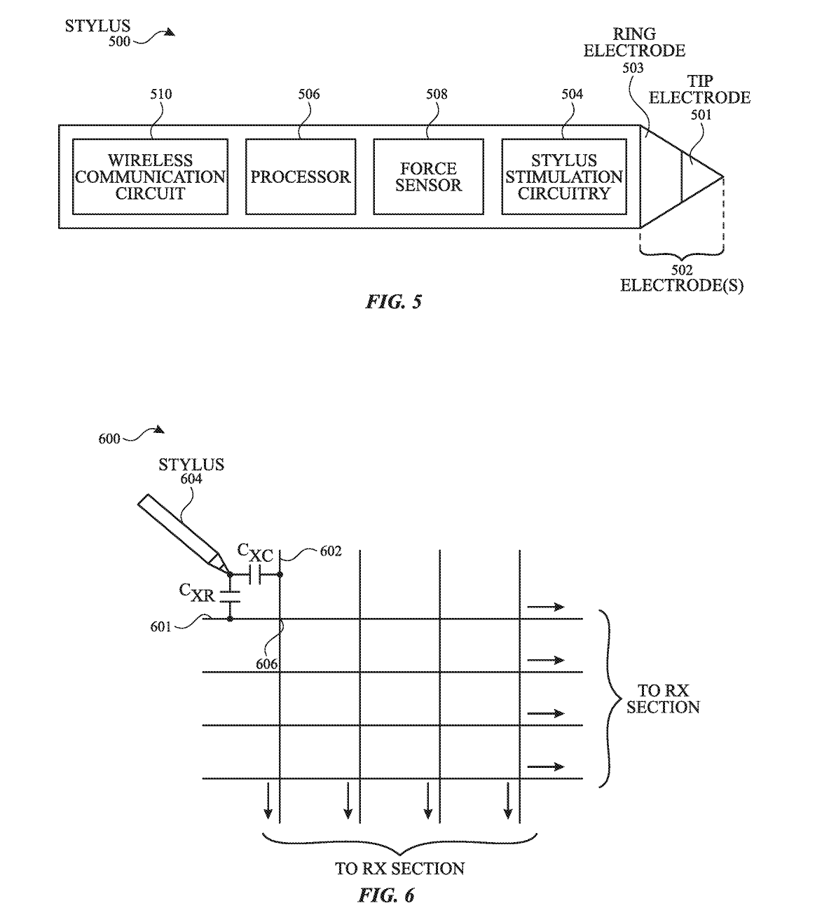

FIG. 6 illustrates an example touch sensor panel configuration operable with the touch ASIC of FIG. 2 to perform a stylus scan according to examples of the disclosure. During a stylus scan, one or more stimulation signals can be injected by stylus 604 proximate to one or more touch nodes 606. The stimulation signals injected by stylus 604 can create capacitive coupling Cxr between the stylus 604 and one or more row traces 601 and capacitive coupling Cxc between the stylus 604 and one or more column traces 602 corresponding to the one or more proximate touch nodes 606. The capacitive coupling Cxr and Cxc between the stylus 604 and the one or more touch nodes 606 can vary based on the proximity of stylus 604 to the one or more touch nodes 606. During the stylus scan, the transmit section 214 can be disabled, i.e., no stimulation signals Vstim from the touch controller are sent to touch sensor panel 600. The capacitive coupling (e.g., mutual capacitance) can be received by the receive section 208 from the row and column traces of the one or more touch nodes 606 for processing. As described herein, in some examples the one or more stylus stimulation signals can have one or more frequencies. The one or more frequencies can be selected by the touch ASIC 201 using information from a stylus spectral analysis scan (described below in more detail). This frequency information can be wirelessly communicated to the stylus 604 so that the stylus 604 can generate stimulation signals at the appropriate frequencies.

In some examples, one or more multiplexers can be used to couple row and/or column electrodes to the receive section and/or transmit section. For example, during a mutual capacitance touch sensing scan, row traces can be coupled to the transmit section and column traces can be coupled to the receive section. During a stylus sensing scan, column traces (or row traces) can be coupled via the one or more multiplexers to the receive section to detect input from a stylus or other input device along one axis of the touch screen, and then the row traces (or column traces) can be coupled via the one or more multiplexers to the receive section to detect input from a stylus or other input device along a second axis of the touch screen. In some examples, the row and column traces can be sensed simultaneously. In some examples, the stylus can be detected on the column traces concurrently with the mutual capacitance scan touch sensing scan. The touch and stylus signals can be differentiated by filtering and demodulating the received response signals at different frequencies.

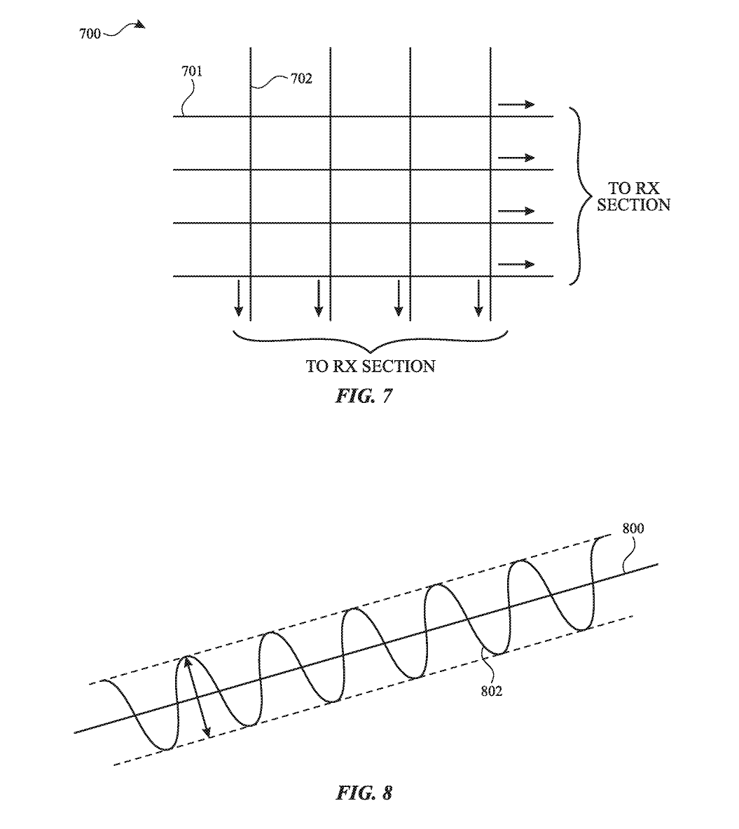

FIG. 7 illustrates an example touch sensor panel configuration operable with the touch ASIC of FIG. 2 to perform a stylus spectral analysis scan according to examples of the disclosure. During a stylus spectral analysis scan or a touch spectral analysis scan, the transmit section 214 can be disabled, i.e., no stimulation signals Vstim are sent to touch sensor panel 700, while some or all of the row traces 701 and column traces 702 can be coupled to the receive section 208. The receive section 208 can receive and process touch signals from some or all of the rows and columns of the touch sensor panel 700 in order to determine one or more low noise frequencies for use during subsequent touch and/or stylus scans.

When the stylus 500 first connects or reconnects wirelessly to the computing system 200 it can receive frequency information from the computing system 200. A stylus spectral analysis scan can determine one or more clean frequencies for the stylus to use to generate one or more stimulation signals. The computing system 200 and stylus 500 can communicate (including, for example, performing a handshake between the two devices) and computing system 200 can transmit the frequency information to the stylus 500 such that the stylus knows the appropriate one or more frequencies to use to generate one or more stimulation signals.

The stylus 500 can change at least one stimulation frequency as a result of a stylus spectral analysis scan. In a synchronous system, a stylus spectral analysis scan can execute while the stylus 500 is predicted to not be generating a stimulation signal, e.g., when a stylus scan is not executing. After completing the stylus spectral analysis scan, the frequency information can be communicated wirelessly to stylus 500 and the communication can cause the stylus 500 to change the one or more stimulation frequencies. The computing system 200 can then switch the one or more frequencies used for demodulating stylus scan events when the stylus 500 has switched frequencies.

In other examples, stylus 500 can be asynchronous such that the stylus 500 can generate one or more stimulation signals at one or more stimulation frequencies irrespective of the timing of the stylus scan event. As a result, the stylus 500 can be stimulating the touch sensor panel during the stylus spectral analysis scan. The asynchronous stylus stimulation signals can cause the computing system to detect a signal when demodulating at the frequency of stimulation, which can be interpreted as noise at that frequency and trigger a frequency switch. In order to prevent triggering an unnecessary frequency switch, the computing system 200 can assume that stylus lift-off will eventually occur and wait until lift-off to initiate a stylus spectral analysis scan. The computing system 200 can predict a lift-off condition using the results of other scans, e.g., stylus scans, or stylus force information to predict that the stylus is not on the panel, and then perform a stylus spectral analysis scan.

The effectiveness of a stylus can depend on the ability to accurately detect the location of the stylus on a touch-sensitive device. The performance of location detection algorithms (i.e., detecting position or coordinates of the stylus on the touch-sensitive device) can depend on the type of algorithm (e.g., a centroid algorithm) and can depend on the signal profile generated in response to stimulation signals from the active stylus.

A wobble metric can be used to measure accuracy of location detection algorithms. Ideally, as an object such as an active stylus traverses between two touch nodes (also referred to as sensing nodes or sensing electrodes), the actual position of the stylus on the touch screen and the detected position of the stylus should be the same. In reality, based on the type of algorithm used to detect position and based on the nature of the coupling between the stylus and the touch sensor panel, the actual and detected positions can be different. The wobble metric can quantify the difference between the actual position and the detected position.

FIG. 8 illustrates an example wobble according to examples of the disclosure. FIG. 8 illustrates line 800 drawn diagonally across a surface of a touch screen, for example, traversing between various touch nodes. Line 800 can also correspond to the detected position for an ideal stylus traversing an ideal touch-sensitive device. Rather than detecting and display a straight line, however, the location detection algorithms can detect and display an oscillating curve 802 that can follow the path of line 800. The oscillation can represent the differences between the actual position and detected position, which can vary depending on the signal profile of the stylus and the relative distance between the stylus and the touch nodes. The wobble metric can be a measure of the absolute amplitude or peak-to-peak amplitude of the oscillating curve 802. The arrow in FIG. 8 illustrates the peak-to-peak amplitude of the oscillating curve 802, which can be a measure of wobble indicative of the accuracy of location detection. The wobble metric can be represented as a peak-to-peak amplitude measured in microns for example. Wobble (e.g., oscillation in a diagonally drawn line) can typically become visible to users at between 50 and 300 microns. Although discussed herein as resulting in an oscillating curve, the differences between actual and detected location can exhibit non-periodic behavior.

As discussed above, the location detection algorithm and signal profile can impact the performance of location detection algorithms. A signal profile can be specific to a given stylus and touch sensor panel. For example, the pitch of the touch sensor panel (spacing between sensing nodes) and the shape of the stylus tip electrode can change the signal profile. The signal profile can also be changed based on the stylus stimulation frequency, orientation of the stylus relative to the touch-sensitive device, and process variation in fabrication of the touch-sensitive device. In some examples, the signal profile can be non-linear such that the signal amplitude measured at touch sensors can be inversely proportional with the square of the distance between the stylus tip electrode and the touch sensor electrodes

$$( i . e . , \frac{1}{{\overline{a}}^{2}} ,$$

where d can represent the distance between the stylus tip electrode and the touch sensor electrodes). In other examples, the signal profile can be inversely proportional with the sum of the square of the distance between the stylus tip electrode and the touch sensor electrodes and the square of a fitting parameter

$$( i . e . , \frac{1}{{\overline{a}}^{2} + {r}^{2}} ,$$

where d can represent the distance between the stylus tip electrode and the touch sensor electrodes and r can represent the fitting parameter). These signal profiles are illustrations of two possible non-linear signal profiles, but other profiles can be possible.

Various location detection algorithms can be used. For example, the location of a stylus on a touch sensor panel can be detected by computing a weighted centroid defined in equation (1):

$${x}_{calc} = \frac{{\sum }_{i = - N}^{N} {x}_{i} {S}_{i}}{{\sum }_{i = - N}^{N} {S}_{i}} \qquad ( 1 )$$

where x_{calc} can be the calculated position along the x-axis, Sᵢ can be the signal measured at the i^{th} sensing electrode along the x-axis, and xᵢ can be the position of the i^{th} sensing electrode along the x-axis. An odd-point centroid algorithm can be used which includes an odd number of sensor measurements to detect position along an axis (e.g., a 3-point centroid, a 5-point centroid, etc.). An even-point centroid algorithm can be used which includes an even number of sensor measurements to detect position along an axis (e.g., a 2-point centroid, a 4-point centroid, etc.) An odd-point centroid can have little or no error in detected location measurements when a stylus touches a touch screen at a point directly above a sensing electrode, but can have considerable error in detected location when a stylus touches a touch screen at a point in between two sensing electrodes, e.g. at half the pitch distance. Conversely, an even-point centroid can have little or no error in detected location when a stylus touches a touch screen at a point in between two sensing electrodes, e.g. at half the pitch distance, but can have considerable error in detected location when a stylus touches a touch screen at a point directly above a sensing electrode. A similar calculation can be performed for the y-axis.

Position can also be calculated, in other examples, based on a ratio of the two largest sensor measurements (Sₙ/Sₙ₊₁, where Sₙ can represent the touch sensor with the largest measurement of signal and Sₙ₊₁ can represent the next largest measurement of signal). In some examples, position can be calculated based on a ratio of the two side lobe signals (Sₙ₋₁/Sₙ₊₁ where Sₙ₋₁ and Sₙ₊₁ can represent the signals at the touch sensors on either side of the touch sensor with the largest measurement of signal).

Ratio-based algorithms, such as the ratio of the two largest signal amplitudes, Sₙ/Sₙ₊₁, and the ratio of the side lobes, Sₙ₋₁/Sₙ₊₁, for example, can have little or no wobble in a low noise condition, but can be more sensitive to noise and therefore can have higher jitter at certain high noise conditions. In contrast, centroid-based algorithms can have improved noise immunity when compared with ratio-based algorithms, but can introduce considerable wobble (which can be dependent on the number of points considered in the n-point centroid).

In some examples, a weighted combination of two position calculation algorithms can be used to reduce wobble. A weighted combination of even-point and odd-point centroids, for example, can be used to take advantage of the respective accuracy of even-point and odd-point centroids based on the location of the stylus relative to the touch sensors. Mathematically, the calculated position using a weighted combination of even-point and odd-point centroids can be expressed as shown in equation (2):

$$position = \frac{{W}_{odd} {C}_{odd} + {W}_{even} {C}_{even}}{{W}_{odd} + {W}_{even}} \qquad ( 2 )$$

where W_{odd} can be the weighting for the odd-point centroid, C_{odd} can be the odd-point centroid calculation, Wₑᵥₑₙ can be the weighting for the even-point centroid, and Cₑᵥₑₙ can be the even-point centroid calculation.

In some example, a single-point transition can be made between using an odd-point centroid calculation and an even-point centroid calculation. The single-point transition can be defined such that the odd-point centroid measurement can be used when the stylus touches a touch screen at a point above a sensing electrode and the even-point centroid can be used as the stylus moves away from an electrode, i.e. when the stylus touches a touch screen at a point between the two sensing electrodes. In some examples, the ratio of the side lobes can be used to define the transition point. In other examples, the weighted combination can be a linear combination of odd-point and even point centroid calculations, rather than using a single transition point. Although described above as a weighted combination of an odd-point centroid and an even-point centroid, the odd-point and even-point centroids can be replaced with other position calculation algorithms.

The number of points in the centroid (or combination of two centroids) can be dependent on the signal profile. For example, for a wider signal profile (i.e., when the signal transmitted from the stylus is received above the noise level at more touch sensors), a higher n-point centroid can reduce the amount of wobble, without introducing much additional noise. In contrast, narrower profiles can benefit from lower n-point centroids, which can avoid adding noise from additional touch sensors (that can lower dots-per-inch (DPI) resolution) without much of an increase in wobble.

In addition to choosing the proper location detection algorithms, the wobble resulting from the location detection algorithm can be further reduced by applying a look-up table (LUT) based correction algorithm. This correction algorithm can be referred to herein as post-processing. For a given signal profile, correction values can be calculated and stored in a LUT. For example, the LUT can store the error in calculated position for each calculated position, which can then be subtracted from (or added to) the calculated position to remove the error (i.e., such that the error in calculated position becomes substantially zero). In other examples, rather than subtracting the error from the calculated position, the LUT can directly map the calculated position to a corrected position. Using a LUT-based correction algorithm after estimating position using location detection algorithms can reduce wobble. A detailed discussion of reducing wobble using post-processing LUT-based correction algorithms can be found in U.S. patent application Ser. No. 14/283,105 entitled “REDUCE STYLUS TIP WOBBLE WHEN COUPLED TO CAPACITIVE SENSOR” by Vivek Pant, et al. (filed 20 May 2014) incorporated by reference in its entirety herein.

Post-processing can be highly effective in reducing wobble, but LUT-based solutions can require that the LUT used for post-processing be specific to hardware and other operating conditions. For example, the LUT can be dependent on the signal profile for the stylus and touch-sensitive device combination, the stimulation frequency, the process variation/gain mismatch, or the orientation of the stylus (e.g., tilt and/or azimuth). These different operating parameters or conditions can be referred to as impairments. For example, as discussed herein, the stylus can generate stimulation signals at different frequencies which can result in different signal profiles. Similarly, the signal profile can be different depending on the orientation of the stylus relative to the touch-sensitive device. Similarly, process variation (gain mismatch) can also exist due to manufacturing differences between sensing electrodes of the touch sensor panels (e.g., sensing electrode, dielectric constants, thickness of glass, etc.) which can lead to different signal profiles. As a result of these impairments, to properly reduce wobble, post-processing can require detecting the state of the stylus, touch sensors, and/or orientation and can require separate LUTs to properly adjust the detected stylus location. These post-processing requirements, however, can increase the complexity and cost of reducing wobble. Post-processing based on various impairments is discussed in more detail below.

Additionally or alternatively, the raw signals received from sensing the touch sensor panels can be processed before applying the position detection algorithms. This processing before the position detection algorithms can be referred to herein as pre-processing. Pre-processing algorithms can be applied to raw signals received from sensing the touch sensors to transform the raw signal profile to match an ideal signal profile. When using centroid algorithms, an ideal profile can be linear and symmetrical around the peak signal measurement. The linear profile can produce accurate location detection results with little or no wobble. Pre-processing the raw signal measurements to linearize the signal profile can improve location detection (reduce wobble) in a way that can be independent of the various impairments, which can result in a simpler, less-expensive solution of reducing wobble across a variety of device and operating conditions. As discussed herein, linearizing the signal profile can refer to modifying the signal profile to be more linear than the raw signal profile. Linearity can be measured, for example, by comparing fitting error between the signal profile and a fitted line (corresponding, for example, to an ideal signal profile). Linearizing the raw signal profile can correspond to having a smaller fitting error for the signal profile after pre-processing as compared with the fitting error for the raw signal profile.

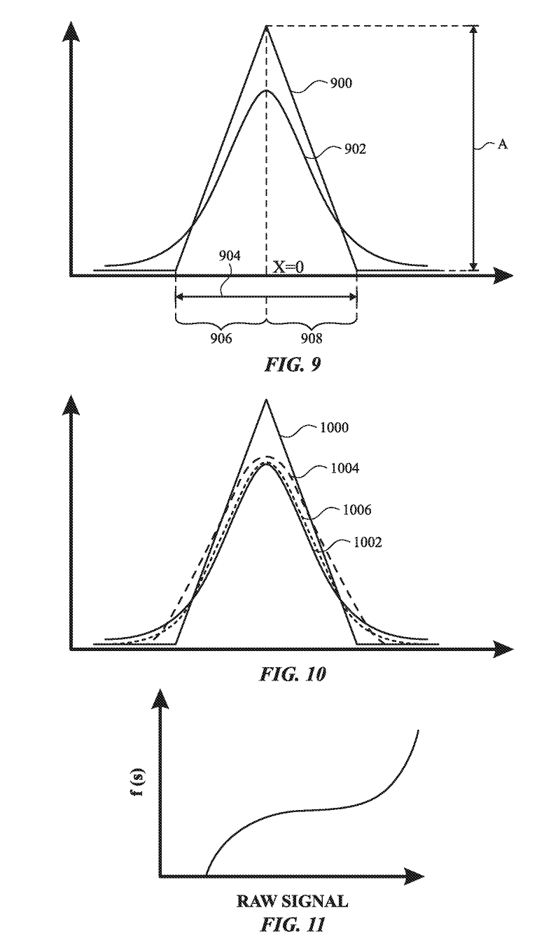

FIG. 9 illustrates an example raw signal profile and an example ideal signal profile according to examples of the disclosure. FIG. 9 illustrates example raw signal profile 902, with the raw signal level plotted on the y-axis and distance plotted on the x-axis. Distance can be measured from x=0, which can represent the location of the sensing electrode receiving the maximum signal level when the stylus is located directly above the electrode. The example raw signal profile 902 can be a non-linear signal profile. The ideal signal profile 900, corresponding to location detection algorithms using n-point centroid calculations, can be a linear profile in contrast to non-linear raw signal profile 902. The linear profile can be symmetric around x=0, forming two sides of an isosceles triangle. The amplitude of the peak of the linear profile, represented by “A” in FIG. 9, can be the same or larger in magnitude as the peak amplitude of the non-linear signal profile. Unlike the raw signal profile 902, which can trail off gradually and non-linearly away from x=0, the ideal profile 900 can have no signal after a threshold distance from x=0. For example, ideal profile 900 can have a width 904 which can define a region of the ideal profile having a non-zero signal. In some examples, the width 904 can be equivalent to the sum of distances 906 and 908 that can be symmetrical around x=0. Each of distances 906 and 908 can be one pitch length (i.e., the distance between two adjacent sensors in an array of sensors). In some examples, distances 906 and 908 can be different from one another and/or can be a distance other than a pitch length. Selecting an ideal signal profile with a width 904 equivalent to at least two times the pitch length can ensure that the stylus profile is not truncated prematurely which can result in a loss of some of the stylus signal.

The width of the ideal profile can be selected based on the type of location detection algorithm. For example, a width of two pitch lengths (one pitch length in each direction) can be the ideal width for a 2-point centroid. For n-point centroids with n>2 the width can be larger. The ideal with can also be different when using a combination of centroid calculations or other location detection algorithms. The ideal width can be determined experimentally, for example, based on determining a width that reduces the wobble for the corresponding sensor and location detection algorithms.

Pre-processing can transform the raw signal profile into a profile resembling or identical to an ideal signal profile. The closer the raw signal profile can be transformed to the ideal profile, the more the wobble can be reduced. At the same time, the dot-per-inch (DPI) performance of the touch screen can decline as the wobble decreases. Thus, the amount of pre-processing transformation to apply can be a tradeoff between reduced wobble and DPI resolution. Although the amount of wobble from a linear profile can be independent of the magnitude of A, the minimum DPI requirement can be a function of the magnitude of A.

FIG. 10 illustrates example modified signal profiles after pre-processing transformation according to examples of the disclosure. Ideal signal profile 1000 and raw signal profile 1002 in FIG. 10 can correspond to the ideal signal profile 900 and raw signal profile 902 in FIG. 9. After applying pre-processing to the raw signals from sensor measurements, the non-linear raw signal profile 1002 can be transformed to have a more linear profile as illustrated by example modified signal profile 1004 and by example modified signal profile 1006. The modified signal profile can be wider, with more linear sides than the original raw signal profile. The pre-processing can also discard measurements from electrodes more than one pitch distance away to modify signal profile. As illustrated by modified signal profiles 1004 and 1006, the pre-processing can generate signal profiles that resemble the ideal profiles, rather than transforming the raw signals into profiles identical to ideal profiles.

Pre-processing raw signals can involve transforming the raw signal measurements from the sensing electrodes using a function. FIG. 11 illustrates an example plot of a function for mapping raw signal measurements to modified signal measurements according to examples of the disclosure. FIG. 11 plots the output of the transformation function, f(S), on the y-axis and plots the raw signal measurement on the x-axis. The function can be a one-to-one function, mapping each input to corresponding output. The function can be selected to map the raw signal profile as closely as possible to the ideal signal profile, when considering the maximum wobble requirement and minimum DPI requirement for the device. As illustrated in the function of FIG. 11, signal measurements below a threshold can be mapped to zero (i.e., discarded or ignored).

In some examples, the pre-processing transform can be a non-linear transform. For example, the transformation function can be represented mathematically by equation (3):

f₁(S)=max(kS−C₁,0)^{C}^{₂} (3)

where f₁(S) can represent the non-linear transformation function, S can represent the raw signal measurement, k can represent a signal profile calibration parameter, and C₁ can C₂ can be constants. Another example transformation function can be represented mathematically by equation (4):

f₂(S)=max(S^{C}^{₃}−C₄,0) (4)

where f₂(S) can represent the non-linear transformation function, S can represent the raw signal measurement, and C₃ can C₄ can be constants.

The pre-processing described herein can be used to widen or narrow a raw signal profile to more closely resemble an ideal signal profile for the selected location detection algorithms. Depending on the specific signal profile for the stylus and touch sensor panel, linearizing the signal profile can result in widening or narrowing the raw signal profile. For example, for the transformed described in equation (3), the signal profile can be widened when using a constant C₂<1 and the signal profile can be narrowed when using a constant C₂>1.

In some examples, the pre-processing can use a LUT to implement the transformation. In other examples, the transformation can be a function applied to the raw signal measurements (e.g., which can be accessed from a memory) using software, firmware, or dedicated hardware. Implementing the pre-processing using a function rather than a LUT can simplify the implementation of the pre-processing transformation.

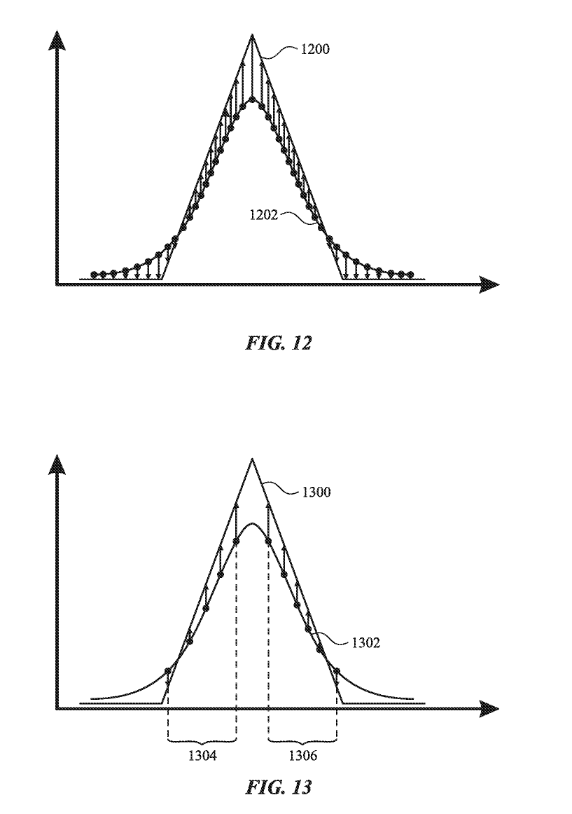

The pre-processing transform can be applied to the entire raw signal profile, in some examples, or to portions of the raw signal profile. FIG. 12 illustrates applying a pre-processing transform to a raw signal profile according to examples of the disclosure. Ideal signal profile 1200 and raw signal profile 1202 in FIG. 12 can correspond to the ideal signal profile 900 and raw signal profile 902 in FIG. 9. In the example of FIG. 12, measurements for the entire profile can be transformed. In contrast, FIG. 13 illustrates applying the pre-processing transform to a portion of the raw signal profile according to examples of the disclosure. Ideal signal profile 1300 and raw signal profile 1302 in FIG. 13 can correspond to the ideal signal profile 900 and raw signal profile 902 in FIG. 9. In the example of FIG. 13, measurements for a portion of the raw signal profile can be transformed. For example, the measurements corresponding to regions 1304 and 1306 can be transformed and the remaining measurements outside of regions 1304 and 1306 can be left as raw measurements.

The example modified signal profile 1004 in FIG. 10 can correspond to transforming the entire signal profile, for example. The example modified signal profile 1006 in FIG. 10 can correspond to transforming a portion of the signal profile, for example. Comparing the example modified signal profiles 1004 and 1006, transforming more of the signal profile can result in a modified signal profile that comes closer to the ideal signal profile. Modified signal profiles 1004 and 1006 can both be wider than raw signal profile 1002. Modified signal profile 1004, however, can be even wider than modified signal profile 1006. Modified signal profiles 1004 and 1006 can both be more linear than raw signal profile 1002. Modified signal profile 1004 can, however, be more linear and across a larger distance than modified signal profile 1006. Modified signal profiles 1004 and 1006 can both truncate the profile faster than raw signal profile 1002. Modified signal profile 1004 can, however, truncate the profile faster and more linearly than modified signal profile 1006.

The range of the signal profile to transform can be determined based on the performance of the location detection algorithm. For example, even-point centroid and odd-point centroids used together can accurately detect position when the stylus touches the touch screen over a sensing electrode or at the mid-point between two sensing electrodes, but can be less effective at one quarter of the pitch distance away from a sensing electrode. The region associated with less effective location detection can be linearized to best benefit from the wobble reduction due to pre-processing. In some examples, the range of the signal profile to transform can be selected to linearize specific portions of the signal profile meeting signal level criteria. For example, the linearized region could apply to portions of the signal profile at which the signal level is between 10%-90% of the peak signal level for the signal profile. In some examples, the range can be smaller, such as between 20%-80% or between 25%-75% of the peak signal level for the signal profile.

Applying the pre-processing transformation to limited regions of the signal profile can require less processing while achieving a significant drop in wobble. Additionally, limiting pre-processing to specific regions can allow for wobble reduction benefits without unnecessarily lowering DPI resolution. Increasing the amount of mapping of the raw signal profile to an ideal signal profile can reduce the DPI resolution, as discussed herein.

In some examples, in addition to limiting the application of the transformation to specific regions of the signal profile, the pre-processing can also truncate measurements distant from the peak of the signal profile. For example, as discussed herein, the pre-processing can discard or ignore all measurements outside a threshold distance from x=0. For example, the threshold distance can be one pitch distance in either direction from x=0. The threshold distance can be larger than one pitch distance in either direction. Alternatively, truncating the raw signal profile can include discarding portions of the signal profile below a threshold signal level (e.g., below 10% of the peak signal level).

Although post-processing to further correct wobble can be difficult to implement due to various impairments, in some cases, post-processing can be performed using any number of LUTs. In some examples, a single global look-up table can be used to reduce wobble across a range of frequencies, orientation angles and process variation conditions. In other examples, a plurality of LUTs can be used. For example, when a stylus changes stimulation frequency, the LUT used to apply post-processing can be a frequency-specific LUT (e.g., one LUT per operating frequency or per a range of frequencies) or the global LUT values can be scaled based on the stimulation frequency. Similarly, when a stylus changes orientation (which can be detected by the stylus or touch-sensitive device using various sensors or algorithms), the LUT used to apply post-processing can be an orientation-specific LUT (e.g., one LUT per tilt angle or per a range of tilt angles) or the global LUT values can be scaled based on the stylus orientation. Likewise, different LUTs can be used to handle process variation differences or global LUT values can be scaled based on the process variation. Although discussed herein separately, there can be LUTs that account for combinations of more than one of the impairments. Alternatively, multiple scaling parameters (corresponding to one or more impairments) can be used in combination to scale the global LUT values to account for one or more of the impairments.

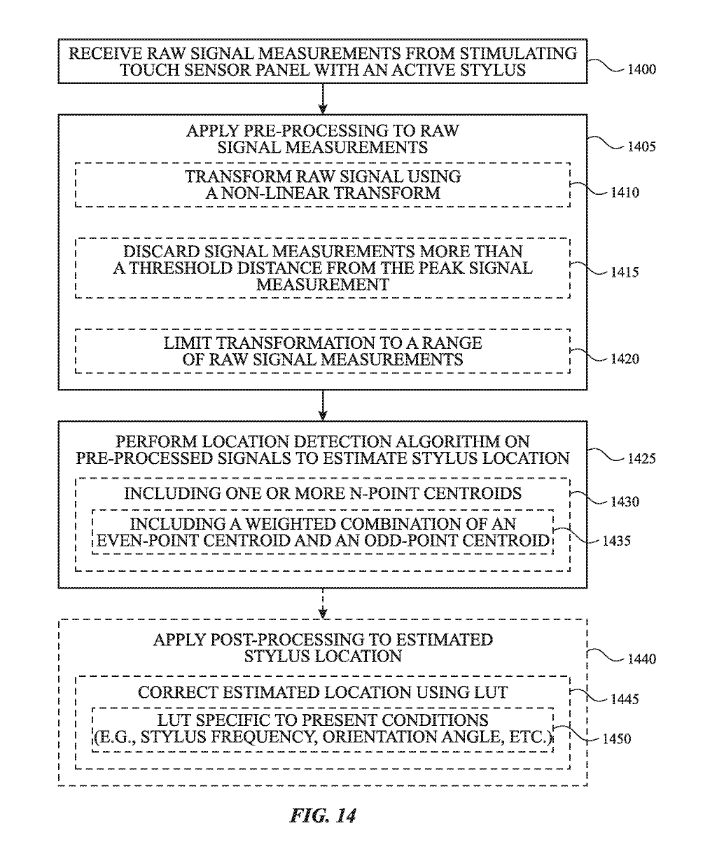

FIG. 14 illustrates an example process for reducing wobble according to examples of the disclosure. The system can perform sensing scans in which stimulation signals from an input device, such as active stylus, can capacitively couple to touch sensing nodes of a touch sensor panel. The resulting sensed signals can be raw signal measurements corresponding to the amount of capacitive coupling at the sensing nodes of the touch sensor panel. The system can receive the raw signal measurements generated from stimulating the touch sensor panel with an active stylus (1400). The system can apply pre-processing to the raw signal measurements (1405). The pre-processing can include transforming at least a portion of the raw signal measurements using a non-linear transform (1410). For example, the non-linear transform can be a one-to-one function mapping raw signal measurements to output modified signal measurements. The pre-processing can transform the non-linear signal profile for the stylus and touch sensor panel into a more linear signal profile approaching or approximating an ideal signal profile to reduce wobble. The pre-processing can also include discarding signal measurements more than a threshold distance from the peak signal measurement for the signal profile (1415). For example, the modified signal profile can be truncated (e.g., by setting some measurements to zero) all signal measurements beyond a pitch distance (or some other threshold distance) from the peak signal measurement for the profile. Additionally or alternatively, the measurements for the modified signal profile can be truncated if the signal level is less than a threshold signal level (e.g., less than 10% of the peak signal level for the profile). In some cases the transformation can be applied to the entire signal profile. In other cases, the transformation can be applied to specific regions of the signal profile, such that the transformation can reduce wobble without unnecessarily degrading the DPI resolution (1420). For example, as described herein, the system can perform the linear transformation on a region of the signal profile defined by distance from the location having peak signal level or based on a range of signals levels (e.g., where the signal level are between 20-80% of the peak signal level of the signal profile).

After pre-processing, the system can perform the location detection algorithm on the modified (pre-processed) signals to estimate the input device location (i.e., stylus location/position) (1425). The location detection algorithm can include one or more n-point centroid algorithm or a ratio based algorithm as discussed herein (1430). In some examples, the location detection algorithm can include an even-point centroid (e.g., 2-point, 4-point, etc.) and an odd-point centroid (e.g., 3-point, 5-point) taken in a weighted combination to estimate the input device location (1435).

In some examples, after estimating the location of the input device, the system can apply post-processing to the estimated stylus location to further reduce wobble (1440). In some examples, a LUT can be used to correct the estimated location by mapping an estimated coordinate to an adjusted coordinate (1445). The LUT can be organized based on coordinate (e.g., x and y parameters) or alternatively the LUT (or axis-specific LUTs) can be used to adjust the estimate in the x and/or y direction). In some examples, the LUT can be a global LUT, applied irrespective of the present conditions of the stylus and touch sensor panel. In other examples, the post-processing can take into account present conditions and select an appropriate LUT specific to the present condition(s) (1450). For example, the system can include different LUTs for different impairments (i.e., parameters that can change the signal profile) such as different stylus stimulation frequencies, different orientation angles, and different process variations (1450). The system can select the appropriate LUT for post-processing based on the one or more present conditions and apply the appropriate adjustment to the estimated input device location. In some examples, the number of LUTs can be reduced by using scaling parameters rather than separated LUTs to handle variations in the conditions. Although the example process discusses performing both pre-processing and post-processing, in some examples, the system can use either pre-processing or post-processing.

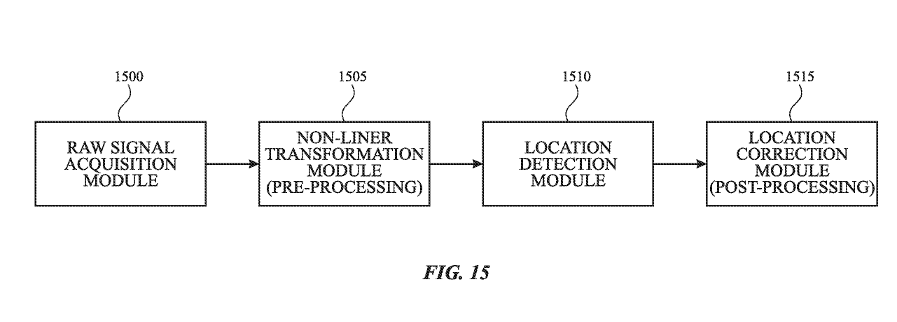

FIG. 15 illustrates an example block diagram of modules configured for reducing wobble according to examples of the disclosure. The block diagram of FIG. 15 illustrates a raw signal acquisition module 1500, a non-linear transformation module 1505, a location detection module 1510 and a location correction module 1515. Each module can be implemented using software, firmware or hardware (or a combination thereof) configured to generate accurate input device location outputs. The raw signal acquisition module 1500 can generate raw signals from sensing the touch sensor panel that has been stimulated by an active stylus, for example. In some examples, the raw signal module can retrieve raw signals stored in memory after sensing functions are performed using the touch sensor panel. The non-linear transformation module 1505 can be configured to apply the pre-processing described herein to the raw signal measurements to generate a modified signal profile. The location detection module 1510 can be configured to perform calculations (e.g., centroid calculations) to estimate a location of the stylus using the pre-processed signal measurements. The location correction module 1515 can be configured to perform the post-processing described herein to further improve the accuracy of location detection for the stylus.

Therefore, according to the above, some examples of the disclosure are directed to a system. The system can comprise one or more processors capable of: receiving raw signal measurements from a plurality of touch sensors stimulated by a powered input device, pre-processing the raw signal measurements to generate modified signal measurements, and estimating a location of the powered input device based on the modified signal measurements. A raw signal profile corresponding to the raw signal measurements can have a non-linear profile and a modified signal profile corresponding to the modified signal measurements can be at least partially linearized compared with the raw signal profile. Additionally or alternatively to one or more of the examples disclosed above, pre-processing the raw signal measurements to generate the modified signal measurements can comprise applying a one-to-one, non-linear transform to the raw signal measurements. Additionally or alternatively to one or more of the examples disclosed above, pre-processing the raw signal measurements to generate the modified signal measurements can comprise applying the one-to-one, non-linear transform to linearize a defined range of the raw signal profile. Additionally or alternatively to one or more of the examples disclosed above, pre-processing the raw signal measurements to generate the modified signal measurements can comprise discarding signal measurements more than a threshold distance from a peak signal measurement. Additionally or alternatively to one or more of the examples disclosed above, pre-processing the raw signal measurements to generate the modified signal measurements can comprise narrowing the raw signal profile. Additionally or alternatively to one or more of the examples disclosed above, pre-processing the raw signal measurements to generate the modified signal measurements can comprise widening the raw signal profile. Additionally or alternatively to one or more of the examples disclosed above, the one or more processors can be further capable of: performing an even-point centroid calculation, and performing an odd-point centroid calculation. Estimating the location of the powered input device can comprise a weighted combination of the even-point centroid calculation and the odd-point centroid calculation. Additionally or alternatively to one or more of the examples disclosed above, the one or more processors can be further capable of: adjusting the estimated location based on one or more values from a look-up-table (LUT). Additionally or alternatively to one or more of the examples disclosed above, the LUT can be selected based on one or more of a detected stimulation frequency and a detected orientation of the powered input device. Additionally or alternatively to one or more of the examples disclosed above, the one or more values from the LUT can be scaled based on one or more of a detected stimulation frequency and a detected orientation of the powered input device.

Some examples of the disclosure are directed to a method for reducing wobble. The method can comprise receiving raw signal measurements from a plurality of touch sensors stimulated by a powered input device, pre-processing the raw signal measurements to generate modified signal measurements and estimating a location of the powered input device based on the modified signal measurements. A raw signal profile corresponding to the raw signal measurements can have a non-linear profile. A modified signal profile corresponding to the modified signal measurements can be at least partially linearized compared with the raw signal profile. Additionally or alternatively to one or more of the examples disclosed above, pre-processing the raw signal measurements to generate the modified signal measurements can comprise applying a one-to-one, non-linear transform to the raw signal measurements. Additionally or alternatively to one or more of the examples disclosed above, pre-processing the raw signal measurements to generate the modified signal measurements can comprise applying the one-to-one, non-linear transform to linearize a defined range of the raw signal profile. Additionally or alternatively to one or more of the examples disclosed above, pre-processing the raw signal measurements to generate the modified signal measurements can comprise discarding signal measurements more than a threshold distance from a peak signal measurement. Additionally or alternatively to one or more of the examples disclosed above, pre-processing the raw signal measurements to generate the modified signal measurements can comprise narrowing the raw signal profile. Additionally or alternatively to one or more of the examples disclosed above, pre-processing the raw signal measurements to generate the modified signal measurements can comprise widening the raw signal profile. Additionally or alternatively to one or more of the examples disclosed above, the method further comprising performing an even-point centroid calculation, and performing an odd-point centroid calculation. Estimating the location of the powered input device can comprise a weighted combination of the even-point centroid calculation and the odd-point centroid calculation. Additionally or alternatively to one or more of the examples disclosed above, the method further comprising adjusting the estimated location based on one or more values from a look-up-table (LUT). Additionally or alternatively to one or more of the examples disclosed above, the LUT can be selected based on one or more of a detected stimulation frequency and a detected orientation of the powered input device. Additionally or alternatively to one or more of the examples disclosed above, the one or more values from the LUT can be scaled based on one or more of a detected stimulation frequency and a detected orientation of the powered input device.

Some examples of the disclosure are directed to a non-transitory computer readable storage medium. The computer readable storage medium can contain instructions that, when executed by one or more processors, can perform a method for reducing wobble. The method can comprise receiving raw signal measurements from a plurality of touch sensors stimulated by a powered input device, pre-processing the raw signal measurements to generate modified signal measurements and estimating a location of the powered input device based on the modified signal measurements. A raw signal profile corresponding to the raw signal measurements can have a non-linear profile. A modified signal profile corresponding to the modified signal measurements can be at least partially linearized compared with the raw signal profile. Additionally or alternatively to one or more of the examples disclosed above, pre-processing the raw signal measurements to generate the modified signal measurements can comprise applying a one-to-one, non-linear transform to the raw signal measurements. Additionally or alternatively to one or more of the examples disclosed above, pre-processing the raw signal measurements to generate the modified signal measurements can comprise applying the one-to-one, non-linear transform to linearize a defined range of the raw signal profile. Additionally or alternatively to one or more of the examples disclosed above, pre-processing the raw signal measurements to generate the modified signal measurements can comprise discarding signal measurements more than a threshold distance from a peak signal measurement. Additionally or alternatively to one or more of the examples disclosed above, pre-processing the raw signal measurements to generate the modified signal measurements can comprise narrowing the raw signal profile. Additionally or alternatively to one or more of the examples disclosed above, pre-processing the raw signal measurements to generate the modified signal measurements can comprise widening the raw signal profile. Additionally or alternatively to one or more of the examples disclosed above, the method further comprising performing an even-point centroid calculation, and performing an odd-point centroid calculation. Estimating the location of the powered input device can comprise a weighted combination of the even-point centroid calculation and the odd-point centroid calculation. Additionally or alternatively to one or more of the examples disclosed above, the method further comprising adjusting the estimated location based on one or more values from a look-up-table (LUT). Additionally or alternatively to one or more of the examples disclosed above, the LUT can be selected based on one or more of a detected stimulation frequency and a detected orientation of the powered input device. Additionally or alternatively to one or more of the examples disclosed above, the one or more values from the LUT can be scaled based on one or more of a detected stimulation frequency and a detected orientation of the powered input device.

Although examples have been fully described with reference to the accompanying drawings, it is to be noted that various changes and modifications will become apparent to those skilled in the art. Such changes and modifications are to be understood as being included within the scope of the various examples as defined by the appended claims.

What is claimed is:

1. A method for reducing wobble, the method comprising:
receiving raw signal measurements from a plurality of touch sensors stimulated by a powered input device, wherein a raw signal profile corresponding to the raw signal measurements has a non-linear profile;
pre-processing the raw signal measurements to generate modified signal measurements, wherein a modified signal profile corresponding to the modified signal measurements is at least partially linearized compared with the raw signal profile; and
estimating a location of the powered input device based on the modified signal measurements.

2. The method of claim 1, wherein pre-processing the raw signal measurements to generate the modified signal measurements comprises applying a one-to-one non-linear transform to the raw signal measurements.

3. The method of claim 2, wherein pre-processing the raw signal measurements to generate the modified signal measurements comprises applying the one-to-one, non-linear transform to linearize a defined range of the raw signal profile.

4. The method of claim 1, wherein pre-processing the raw signal measurements to generate the modified signal measurements comprises discarding signal measurements more than a threshold distance from a peak signal measurement.

5. The method of claim 1, wherein pre-processing the raw signal measurements to generate the modified signal measurements comprises narrowing or widening the raw signal profile.

6. The method of claim 1, further comprising:
adjusting the estimated location based on one or more values from a look-up-table (LUT).

7. The method of claim 6, wherein the LUT is selected based on one or more of a detected stimulation frequency and a detected orientation of the powered input device.

8. The method of claim 6, wherein the one or more values from the LUT are scaled based on one or more of a detected stimulation frequency and a detected orientation of the powered input device.

9. A system for reducing wobble, the system comprising:
one or more processors capable of:
receiving raw signal measurements from a plurality of touch sensors stimulated by a powered input device, wherein a raw signal profile corresponding to the raw signal measurements has a non-linear profile;
pre-processing the raw signal measurements to generate modified signal measurements, wherein a modified signal profile corresponding to the modified signal measurements is at least partially linearized compared with the raw signal profile; and
estimating a location of the powered input device based on the modified signal measurements.

10. The system of claim 9, wherein pre-processing the raw signal measurements to generate the modified signal measurements comprises applying a one-to-one, non-linear transform to the raw signal measurements.

11. The system of claim 10, wherein pre-processing the raw signal measurements to generate the modified signal measurements comprises applying the one-to-one, non-linear transform to linearize a defined range of the raw signal profile.

12. The system of claim 9, wherein pre-processing the raw signal measurements to generate the modified signal measurements comprises discarding signal measurements more than a threshold distance from a peak signal measurement.

13. The system of claim 9, wherein pre-processing the raw signal measurements to generate the modified signal measurements comprises narrowing or widening the raw signal profile.

14. The system of claim 9, the one or more processors further capable of:
adjusting the estimated location based on one or more values from a look-up-table (LUT).

15. The system of claim 14, wherein the LUT is selected based on one or more of a detected stimulation frequency and a detected orientation of the powered input device.

16. The system of claim 14, wherein the one or more values from the LUT are scaled based on one or more of a detected stimulation frequency and a detected orientation of the powered input device.

17. A non-transitory computer readable storage medium, the computer readable storage medium containing instructions that, when executed by one or more processors, perform a method for reducing wobble, the method comprising:
receiving raw signal measurements from a plurality of touch sensors stimulated by a powered input device, wherein a raw signal profile corresponding to the raw signal measurements has a non-linear profile;
pre-processing the raw signal measurements to generate modified signal measurements, wherein a modified signal profile corresponding to the modified signal measurements is at least partially linearized compared with the raw signal profile; and
estimating a location of the powered input device based on the modified signal measurements.

18. The non-transitory computer readable storage medium of claim 17, wherein pre-processing the raw signal measurements to generate the modified signal measurements comprises applying a one-to-one, non-linear transform to the raw signal measurements.

19. The non-transitory computer readable storage medium of claim 18, wherein pre-processing the raw signal measurements to generate the modified signal measurements comprises applying the one-to-one, non-linear transform to linearize a defined range of the raw signal profile.

20. The non-transitory computer readable storage medium of claim 17, wherein pre-processing the raw signal measurements to generate the modified signal measurements comprises discarding signal measurements more than a threshold distance from a peak signal measurement.

21. The non-transitory computer readable storage medium of claim 17, wherein pre-processing the raw signal measurements to generate the modified signal measurements comprises narrowing or widening the raw signal profile.

22. The non-transitory computer readable storage medium of claim 17,
the instructions perform the method further comprising:
adjusting the estimated location based on one or more values from a look-up-table (LUT).

23. The non-transitory computer readable storage medium of claim 22, wherein the LUT is selected based on one or more of a detected stimulation frequency and a detected orientation of the powered input device.

24. The non-transitory computer readable storage medium of claim 22, wherein the one or more values from the LUT are scaled based on one or more of a detected stimulation frequency and a detected orientation of the powered input device.
